(19) United States
(12) Patent Application Publication
(10) Pub. No.: US 2013/0112870 A1
(43) Pub. Date: May 9, 2013

(54) HOLLOW CYLINDRICAL ANALYZER

(71) Applicants: Victor Gorelik, Brooklyn, NY (US); Tatiana Gorelik, Brooklyn, NY (US); Natalia Hanson, Brooklyn, NY (US)

(72) Inventors: Victor Gorelik, Brooklyn, NY (US); Tatiana Gorelik, Brooklyn, NY (US); Natalia Hanson, Brooklyn, NY (US)

(21) Appl. No.: 13/289,814

(22) Filed: Nov. 4, 2011

(51) Int. Cl. H01J 49/48

(52) U.S. Cl. 250/305

(57) ABSTRACT

The invention provides constructions of an energy analyzer with entrance angles slightly greater than π/2. The analyzer is capable of collecting electrons in 2π azimuth directions, has a high energy resolution, and a large entrance solid angle. The analyzer is compatible with transmission electron microscopy and other surface analysis techniques.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates generally to surface analysis apparatus and in particular to an energy analyzer based on a combination of hollow cylindrical fields.

Studying of nano-objects located on a surface is a common task of modern science and technology. Especially valuable information can be obtained if a high spatial resolution image of a surface is acquired simultaneously with high energy resolution spectra of a nano-object. Such complex data allows extracting additional elemental and chemical information about a nano-object of interest.

The problem of getting a high quality image of a surface along with high quality spectra of a nano-object is that it is difficult to combine the lens of an electron/ion source with an energy analyzer since the lens is short-focused.

A known solution for this problem is described in the U.S. Pat. No. 4,224,518 by Norman J. Taylor; Varian Associates, Inc. In this solution, a multi-stage cylindrical mirror analyzer (CMA) incorporates an electron gun located internally, along the axis of the analyzer.

Another solution is being used by Physical Electronics Industries, Inc. In this solution, only the objective lens of a scanning electron microscope is placed inside of a cylindrical mirror analyzer (CMA).

One more solution is described in the U.S. Pat. No. 8,013,298 by Anjam Khursheed; National University of Singapore. In this invention, a radian collection second-order focusing toroidal analyzer fits around an electron/ion source.

All mentioned above solutions/analyzers are designed to work with high spatial resolution systems like, for example, Scanning Auger Microscopes. However, due to construction characteristics of the analyzers, e.g., ranges of entrance angles, these solutions/analyzers are not compatible with super-high spatial resolution systems like, for example, a transmission electron microscope.

The solution for an energy analyzer combined with a transmission electron microscope is described in the U.S. Pat. No. 5,097,126 by Ondrej L. Krivanek; Gatan, Inc. In this solution, the analyzer is located under the specimen. Electrons enter the analyzer after they pass through the objective and projective lenses of the microscope. As a result, the central entrance angle of the electrons in the Gatan energy analyzer is equal to zero as opposed to 42° in a cylindrical minor analyzer (CMA). The electron collection half-angle is typically equal to 20 mrad in a Gatan energy analyzer, so its corresponding collection solid angle is hundreds times less than in a CMA. This fact dramatically reduces signal to noise ratio and imposes restrictions on many important experiments. Besides, the collected electrons represent mainly the properties of deep layers of the specimen, not the properties of its surface

### SUMMARY OF THE INVENTION

It is therefore an objective of this invention to propose an analyzer with entrance angles of electrons slightly greater than π/2 (90.5°-98.5°) as opposed to 42° in a CMA and to 0° in a Gatan analyzer. Such a construction of the analyzer ensures that collected electrons represent mostly surface information; for example, in case of using the analyzer for electron energy loss spectroscopy, collected electrons represent surface plasmons, not bulk plasmons.

It is another objective of the present invention to propose an analyzer compatible with transmission electron spectroscopy and at the same time having high energy resolution, the property of focusing of the second order and, as a result, having the electron collection solid angle (and signal to noise ratio) comparable to a classical CMA. The analyzer is compatible not only with transmission electron microscopy but with a wide range of other techniques. Due to the open access to the specimen, it is possible to use primary photon, electron, and ion beams simultaneously. The analyzer can also be combined with scanning probe microscopes. The described configuration features of the analyzer along with its high electro-optical characteristics exhibit significant advantages of the analyzer compared to known prototypes. Another important advantage of the analyzer is simplicity of its construction, which guarantees the precision of its manufacturing. As a result, the actual electron-optical characteristics of the manufactured analyzer get close to the calculated ones.

### BRIEF DESCRIPTION OF THE DRAWINGS

FIG. 1 illustrates a one-pass hollow cylindrical analyzer.

FIG. 2 illustrates focusing properties of a one-pass hollow cylindrical analyzer.

FIG. 3 illustrates the configuration of a two-pass hollow cylindrical analyzer and a transmission electron microscope.

### DETAILED DESCRIPTION OF SPECIFIC EMBODIMENTS

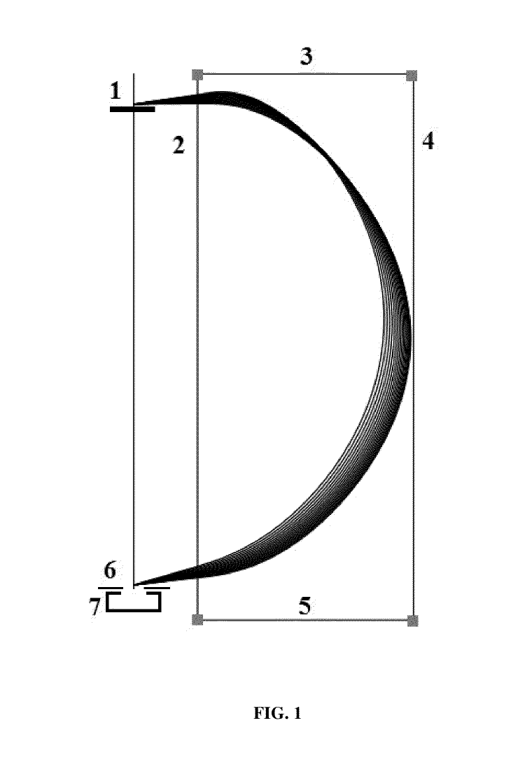

FIG. 1 illustrates the one-pass hollow cylindrical analyzer proposed in the present invention. Electrons emitted by or scattered from the specimen 1 enter the field of the analyzer though the upper windows in the inner cylinder 2, which has a zero potential. The electrons make two U-turns (one U-turn in the z-direction and the other—in the r-direction) in the field created by the potential of the lid 3 of the analyzer, the potential of the outer cylinder 4, and the potential of the lid 5 of the analyzer and then leave the field trough the bottom windows in the inner cylinder 2. After that, the electrons go through the diaphragm 6 to the collector 7.

For the purpose of further explanations, the following notation is going to be used. The potentials are: 0—for the inner cylinder 2, V₃—for the lid 3, V₄—for the outer cylinder 4, and V₅—for the lid 5. The coordinate origin is the center of the lid 3. The radius of the outer cylinder 4 is chosen as the length unit, the radius of the inner cylinder 2 is R, the height of the cylinders is H, the z-coordinate of the specimen 1 is z₁, the z-coordinate of the diaphragm 6 is z₆, and the diameter of the diaphragm 6 is d₆.

Due to simple geometry of a hollow cylinder, it is not difficult to write down the component E_{z} of the electrostatic field along the axis z and the component Eᵣ in the perpendicular direction r:

E_{z}(r, z)=V₅*L_{z}(r, z)−V₅*L_{z}(r, H−z)+V₄*C_{z}(r, z)

Eᵣ(r, z)=V₅*Lᵣ(r, z)+V₃*Lᵣ(r, H−z)+V₄*Cᵣ(r, z),

where L stands for Lid, C stands for Cylinder, and

$${L}_{z} ( r , z ) = {\sum }_{m = 1}^{∞} \frac{{α}_{m} {J}_{0} ( {α}_{m} R )}{sinh ( {α}_{m} H ) [ {J}_{0} ( {α}_{m} R ) + {J}_{0} ( {α}_{m} ) ]} cosh ( {α}_{m} z ) {W}_{0} ( {α}_{m} , {α}_{m} r )$$

$${L}_{r} ( r , z ) = {\sum }_{m = 1}^{∞} \frac{{α}_{m} {J}_{0} ( {α}_{m} R )}{sinh ( {α}_{m} H ) [ {J}_{0} ( {α}_{m} R ) + {J}_{0} ( {α}_{m} ) ]} sinh ( {α}_{m} z ) {W}_{1} ( {α}_{m} , {α}_{m} r )$$

$${C}_{z} ( r , z ) = {\sum }_{m = 1}^{∞} \frac{2 [ 1 - {( - 1 )}^{m} ]}{V ( {β}_{m} , {β}_{m} R ) H} cos ( {β}_{m} z ) {V}_{0} ( {β}_{m} r , {β}_{m} R )$$

$${C}_{r} ( r , z ) = {\sum }_{m = 1}^{∞} \frac{2 [ 1 - {( - 1 )}^{m} ]}{V ( {β}_{m} , {β}_{m} R ) H} sin ( {β}_{m} z ) {V}_{1} ( {β}_{m} r , {β}_{m} R )$$

$${W}_{0} ( x , y ) = {Y}_{0} ( x ) {J}_{0} ( y ) - {Y}_{0} ( y ) {J}_{0} ( x )$$

$${W}_{1} ( x , y ) = {Y}_{1} ( y ) {J}_{0} ( x ) - {Y}_{0} ( x ) {J}_{1} ( y )$$

$${V}_{0} ( x , y ) = {I}_{0} ( x ) {K}_{0} ( y ) - {I}_{0} ( y ) {K}_{0} ( x )$$

$${V}_{1} ( x , y ) = {I}_{1} ( x ) {K}_{0} ( y ) + {I}_{0} ( y ) {K}_{1} ( x )$$

$${β}_{m} = m π / H$$

αₘ are the solutions (in the ascending order) of the equation

Y₀(α)J₀(αR)=Y₀(αR)J₀(α)

and

Y₀(x), J₀(x), Y₁(x), J₁(x)—Bessel functions of integer order,

I₀(x), K₀(x), I₁(x), K₁(x)—modified Bessel functions of integer order.

The electrons' trajectories are calculated by the modified Runge-Kutta method; see William H. Press, Saul A. Teukolsky, William T. Vetterling, Brian P. Flannery; Numerical Recipes in C, The Art of Scientific Computing, Second Edition, Cambridge University Press, New York, 1988.

The one-pass hollow cylindrical analyzer shown in FIG. 1 is described by the parameters z₁=0.11, H=1.95, R=0.225, V₃=V₄=1.4, V₅=1.43, z₆=1.8231, and the central kinetic energy of collected electrons E=1.7.

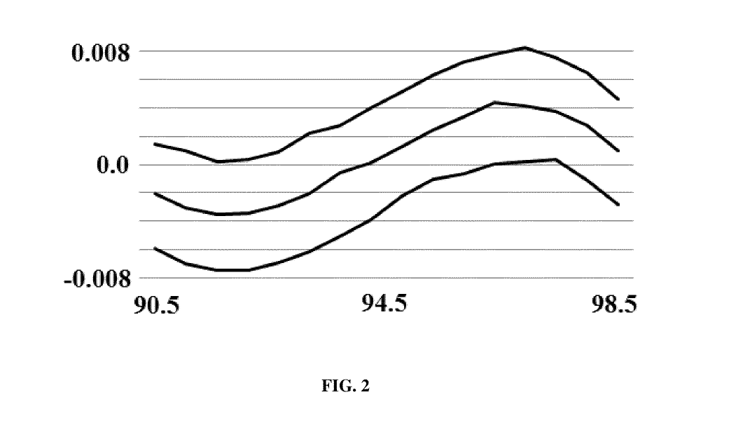

FIG. 2 illustrates how the r-coordinate of an electron in the plane of the diaphragm 6 in the analyzer shown in FIG. 1 depends on the entrance angle. The middle line in FIG. 2 corresponds to the kinetic energy of the electron E=1.7, the top line—to E=1.7*1.0005, and the bottom line—to E=1.7/1.0005. FIG. 2 implies that for the diapason of entrance angles from 90.5° to 98.5° (the entrance solid angle of 0.87 steradians), the diameter of the diaphragm d₆ is equal to 0.008 and that the base energy resolution of the analyzer is equal to 0.2%. This resolution is better than the resolution of a three-pass cylindrical analyzer with the same entrance solid angle; see Gorelik V. A., Mashinskii Y. P., Pikovskaya T. M., Protopopov O. D.; Three-pass cylindrical minor analyzer with fourth-order focusing, Zh. Tech. Fiz.—1982, v.2, pp.412-414.

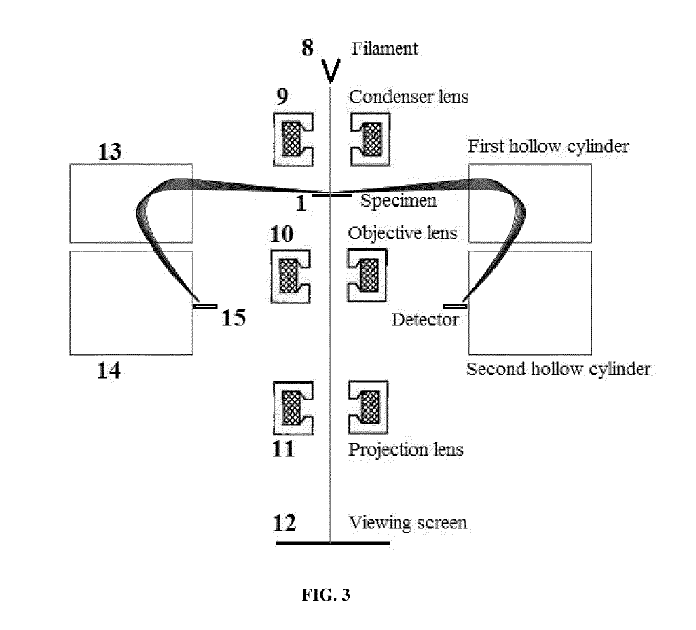

FIG. 3 illustrates the two-pass hollow cylindrical analyzer proposed in the present invention. The analyzer is based on the electrostatic field created by two hollow cylinders, which fit around the objective imaging lens of a transmission electron microscope. Primary electrons are emitted by the filament 8 and focused by the condenser lens 9 on the specimen 1. Then the electrons go through the specimen 1, through the objective lens 10, and the projection lens 11 and reach the viewing screen 12. The filament 8, the lenses 9, 10, and 11, and the viewing screen 12 are the elements of the transmission electron microscope. Secondary electrons are backscattered/emitted from the central point of the specimen 1 in all radial directions. Then the electrons go through the first hollow cylinder 13 and the second hollow cylinder 14. After that, they are being focused at the ring-shaped detector 15. The role of the first hollow cylinder of the analyzer is to retard the electrons, and the role of the second one is to focus the electrons effectively.

The analyzer shown in FIG. 3 is described by the following parameters. The hollow cylinders 13 and 14 have the same radius of their outer cylinders. This radius is chosen as the unit length. The hollow cylinders 13 and 14 also have the same radius of their inner cylinders. This radius is equal to 0.53. The height of the cylinder 13 is 0.3 and the height of the cylinder 14 is 0.4. The potentials of the inner cylinder, the upper lid, the outer cylinder, and the lower lid of the hollow cylinder 13 are 0, 2.45, 5.3, and 2 respectively; the similar potentials of the hollow cylinder 14 are 2.2, 2, 2.75, and 2.475. The central kinetic energy E=2.43. The center of the upper lid of the cylinder 13 is the coordinate origin; the z-coordinate of the specimen 1 is 0.11; the z-distance between the two hollow cylinders is 0.03; the z-coordinate of the exit slit in the inner cylinder of the hollow cylinder 14 is 0.50. For the range of entrance angles from 90.5° to 95.5° (the entrance solid angle of 0.55 steradians), the width of the slit is 0.008 and the base energy resolution is 0.2%. This resolution is approximately equal to the resolution of a classical cylindrical analyzer with the same entrance solid angle. The entrance solid angle of the proposed two-pass hollow cylindrical analyzer is hundreds times greater than the entrance solid angle of its prototype—the Gatan analyzer.

The proposed two-pass hollow cylindrical analyzer has the following advantages. High energy resolution of the analyzer guarantees that the specimen's spectrum will have fine chemical structure; the central entrance angle that is close to π/2 makes the obtained information extremely surface sensitive; the large entrance solid angle of the analyzer dramatically increases signal to noise ratio. The analyzer is compatible not only with transmission electron microscopy but with a wide range of other techniques. Due to the open access to the specimen, it is possible to use primary photon, electron, and ion beams simultaneously. The analyzer can also be combined with scanning probe microscopes. The described configuration features of the analyzer along with its high electro-optical characteristics and really simple construction exhibit a great commercial potential for the analyzer.

Although the present invention has been described in terms of the preferred embodiments, it is to be understood that the disclosure is not to be interpreted as limiting. Various modifications will become apparent to those skilled in the art after having read this disclosure. For example, any outer cylinder in a hollow cylindrical analyzer can be made of several stacked cylinders of the same radius where each cylinder has its own potential. Similarly, any lid in the analyzer can be made of several lids of increasing radiuses: all the lids are located in the same plane and have their own potentials. These modifications do not change the formulas and calculations dramatically. Accordingly, it is intended that the appended claims be interpreted as covering all alterations and modifications within the spirit and scope of the invention.

1. An electrostatic electron spectrometry apparatus, comprising:
a source of electrons and
a spectrometer that includes at least one hollow cylindrical analyzer having an electrically conductive inner cylinder coupled to a source of voltage, an electrically conductive upper lid coupled to another source of voltage, an electrically conductive outer cylinder coupled to yet another source of voltage, and an electrically conductive lower lid coupled to yet another source of voltage
wherein the spectrometer is configured so that the electrons emitted from the source enter the hollow cylindrical analyzer through the widows in the inner cylinder, make at least one U-turn in the direction of the axis of the hollow cylinder analyzer, and then the electrons are being collected by a detector.

2. The electrostatic electron spectrometry apparatus of claim 1 wherein electrons enter the spectrometer within the diapason 90.5°-98.5° of entrance angles in respect to the axis of the hollow cylinder analyzer, move in radial directions, and then the electrons are being collected in full azimuth directions.

3. An electrostatic electron spectrometry apparatus, comprising:
the hollow cylindrical analyzer of claim 1 and
a transmission electron microscope
wherein the analyzer and the microscope are configured so that the electrons emitted from the specimen of the microscope within the diapason 90.5°-95.5° in respect to the axis of the microscope enter the analyzer, move through the electrostatic field of the analyzer, and then the electrons are being collected by a detector.

4. The electrostatic electron spectrometry apparatus of claim 3 wherein the analyzer comprises at least two hollow cylindrical analyzers and fits around the objective lens of the microscope.
